(19) United States
(12) Patent Application Publication
(10) Pub. No.: US 2010/0169106 A1
(43) Pub. Date: Jul. 1, 2010

(54) SYSTEM AND METHOD FOR PROFILING JURORS

(76) Inventors: William Powers, West Stockbridge, MA (US); John Zogby, New Hartford, NY (US); James Shahen, Altamont, NY (US); Andrew Stemmer, Utica, NY (US); Qianqing Ren, Utica, NY (US); Jason Powers, Valatie, NY (US)

Correspondence Address: HOFFMAN WARNICK LLC, 75 STATE STREET, 14TH FLOOR, ALBANY, NY, 12207, US

(21) Appl. No.: 12/345,853

(22) Filed: Dec. 30, 2008

(51) Int. Cl. G06Q 10/00; G06Q 90/00

(52) U.S. Cl. 705/1.1; 705/321

(57) ABSTRACT

A jury profiling system and method. A profiling system is provided that includes: A profiling system for profiling prospective jurors, comprising: a system for generating a case specific scoring table based on a set of survey data, wherein the survey data includes attribute data for a set of respondents and liability findings from the set of respondents for at least one hypothetical case, wherein the case specific scoring table provides a score for each of a plurality of attribute combinations; an attributed jury pool database for storing a set of attributed juror records; an interface for selecting a potential juror from the attributed jury pool database; and a system for scoring the potential juror by comparing attributes of the potential juror with the attribute combinations in the case specific scoring table.

### BACKGROUND OF THE INVENTION

1. Technical Field

The present invention relates generally to profiling individuals participating in a legal process, and more specifically relates to a system and method of profiling jurors using demographic attributes, survey data and models.

2. Related Art

In important legal cases, such as criminal prosecution and civil matters involving large sums of money, jury selection is often critical to the outcome of a trial. The process of selecting a jury, referred to as voire dire, often involves a significant amount of guesswork based on assumptions, instinct and intuition on the part of the lawyer handling the case.

To improve the chances of selecting a favorable jury, practitioners may utilize well-known jury profiling techniques. For example, a person living in an upscale neighborhood may be more likely to be pro big business, or be harder on crime. In general, the more attributes one knows about an individual (e.g., age, race, political affiliations, gender, address, income, etc.), the more accurate the profile. However, even with such attributes, jury profiling can be more of an art than a science.

Moreover, in a jury selection setting, obtaining and processing attribute information in a timely matter remains a challenge.

### SUMMARY OF THE INVENTION

The present invention addresses the above-mentioned problems, as well as others, by providing an on-line system and method for profiling jurors and others involved in a legal proceeding, and providing profiling data (e.g., a score or narrative) for those profiled. In a first aspect, the invention provides a profiling system for profiling prospective jurors, comprising: a system for generating a case specific scoring table based on a set of survey data, wherein the survey data includes attribute data for a set of respondents and liability findings from the set of respondents for at least one hypothetical case, wherein the case specific scoring table provides a score for each of a plurality of attribute combinations; an attributed jury pool database for storing a set of attributed juror records; an interface for selecting a potential juror from the attributed jury pool database; and a system for scoring the potential juror by comparing attributes of the potential juror with the attribute combinations in the case specific scoring table.

In a second aspect, the invention provides a computer readable medium having a computer program product stored thereon for profiling prospective jurors, comprising: program code for generating a case specific scoring table based on a set of survey data, wherein the survey data includes attribute data for a set of respondents and liability findings from the set of respondents for at least one hypothetical case, wherein the case specific scoring table provides a score for each of a plurality of attribute combinations; program code for selecting a potential juror from an attributed jury pool database; and program code for scoring the potential juror by comparing attributes of the potential juror with the attribute combinations in the case specific scoring table.

In a third aspect, the invention provides a method for profiling prospective jurors, comprising: generating a case specific scoring table based on survey data, wherein the survey data includes attribute data for a set of respondents and liability findings from the set of respondents for at least one hypothetical case, wherein the case specific scoring table provides a score for each of a plurality of attribute combinations; selecting a potential juror from an attributed jury pool database; and scoring the potential juror by comparing attributes of the potential juror with the attribute combinations in the case specific scoring table.

In a fourth aspect, the invention provides a profiling system for profiling prospective jurors, comprising: a case management system for selecting a case from a set of cases, wherein each of the set of cases includes a case specific scoring table based on a set of survey data, wherein the survey data includes attribute data for a set of respondents and liability findings from the set of respondents for at least one hypothetical case, wherein each case specific scoring table provides a set of scores for each of a plurality of attribute combinations; an attributed jury pool database for storing a set of attributed juror records; an interface for selecting a potential juror from the attributed jury pool database; and a system for scoring the potential juror by comparing attributes of the potential juror with the attribute combinations in a case specific scoring table associated with a selected case.

### BRIEF DESCRIPTION OF THE DRAWINGS

The embodiments of this invention will be described in detail, with reference to the following figures, wherein like designations denote like elements, and wherein:

FIG. 1 shows a block diagram of an on demand profiling system in accordance with the present invention.

FIG. 2 depicts a survey data processing system in accordance with the present invention.

FIG. 3 depicts an attribute system in accordance with the present invention.

FIG. 4 depicts an attributed set of juror records in accordance with the present invention.

FIG. 5 depicts a ranked set of juror scores in accordance with the present invention.

FIG. 6 depicts an illustrative set of juror data generated in accordance with the present invention.

### DETAILED DESCRIPTION OF THE INVENTION

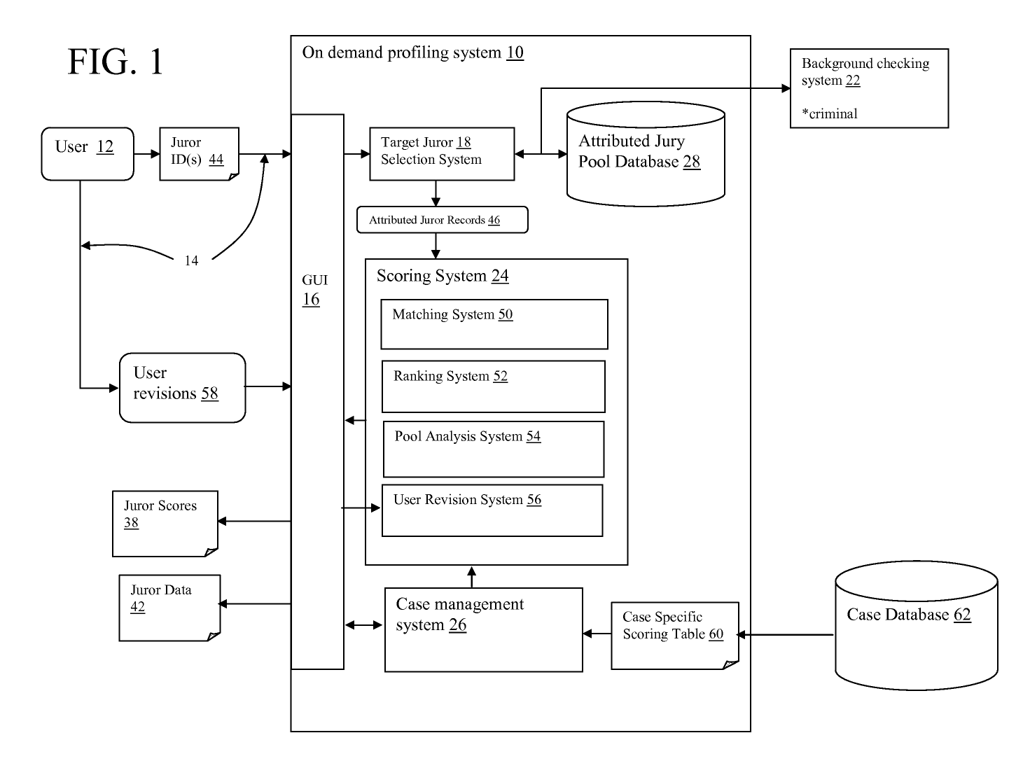

Referring now to FIG. 1, an on-demand profiling system 10 is shown that allows a user 12 to obtain profile data about a prospective juror (or set of jurors) in a legal proceeding in an on demand or real-time manner. In this illustrative embodiment, on-demand profiling system 10 provides to the user 12 profile data comprising a ranked set of juror scores 38 and associated juror data 42 for a prospective set of jurors. The juror scores 38 indicate a likelihood or bias of a given juror. Namely, in the embodiments described herein, each score provides a likelihood that the juror will find for the plaintiff. Note that the juror scores 38 could just as well be implemented to indicate the likelihood the juror would find for the defendant. Also note that while the illustrative embodiment shown in FIG. 1 is described with reference to profiling a juror, the processes and systems described therein could be applied to profiling any individual in any setting.

In operation, user 12 (e.g., a lawyer who subscribes to the service) interfaces with on-demand profiling system 10 via a graphical user interface GUI 16 over a network 14 such as the Internet via a wired or wireless connection. To obtain profile data, the user 12 first logs onto on-demand profiling system 10 and is presented with GUI 16. From within GUI 16, the user 12 can then provide some type of a juror ID 44 for each prospective, or “target” juror. The juror ID 44 may for instance comprise a name and/or other relevant information, e.g., address, phone number, date of birth, etc. Alternatively, GUI 16 may include an interface to allow the user 12 to submit an entire set or list of prospective jurors, such as a jury pool.

Once entered, target juror selection system 18 searches the attributed jury pool database 28 to find the target juror (or jurors) entered by user 12. For each target juror entered, target juror selection system 18 would return a match or list of possible matches (e.g., John Smith residing at address 1, John Smith 2 residing at address 2, etc.). In the case where a list of possible matches was returned, user 12 could then select the appropriate match.

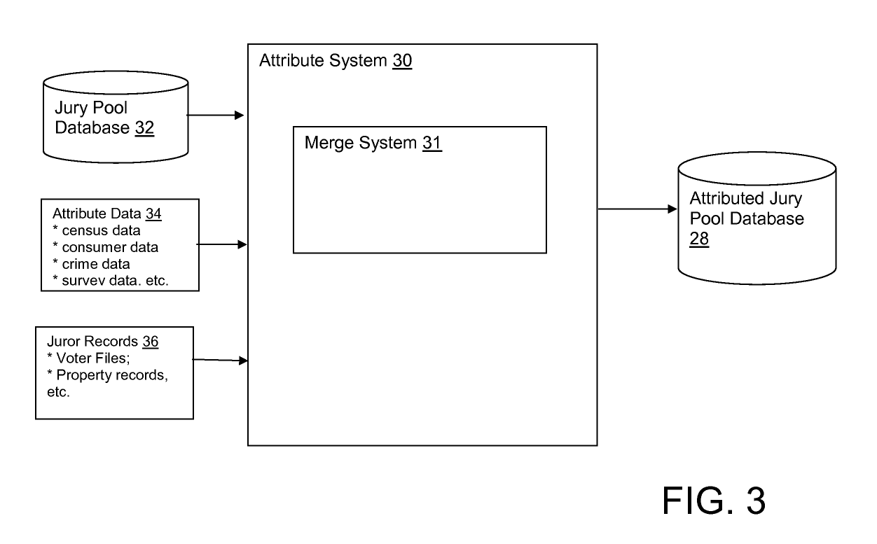

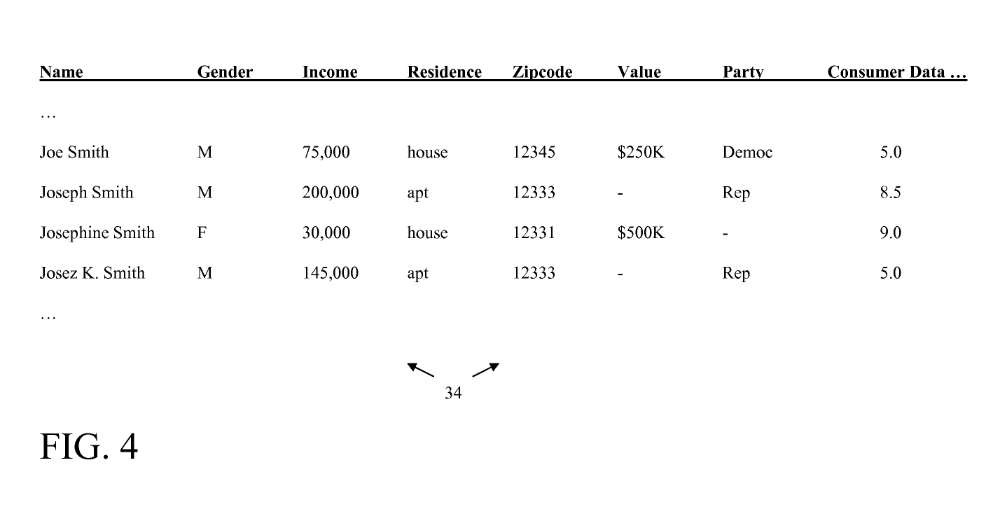

The attributed jury pool database 28 generally comprises a list of all of the available jurors for the particular jurisdiction (e.g., county) along with a set of attributes for each juror. FIGS. 3 and 4, discussed below, depict an attribute system 30 for building the attributed jury pool database 28 and an illustrative set of attributed juror records 44, respectively. In a typical embodiment, the attributed jury pool database 28 is built ahead of time and is then loaded into or made accessible to the on demand profiling system 10.

In addition to selecting jurors, the user 12 can also select the specific case or case type being tried via case management system 26. Depending on the selection, a case specific scoring table 60 is loaded from a case database 62, which is used by the scoring system 24 to score jurors for the case being tried. In one illustrative embodiment, case specific scoring table 60 is built based on a custom survey performed for the specific case being tried. For example, if the case being tried is a negligence case involving an individual suing a large company in county A, a survey involving fact patterns of the case would be performed ahead of time to question individuals in county A to determined attitudes, attributes, demographics, likely outcomes, etc., from a set of participants. Based on the survey results, a case specific scoring table 60 would be built and stored in case database 62 for the case. In an alternative embodiment, the user 12 may simply select a case from the case database 62 that closely resembles the facts, location and legal issues of the case being tried. In response to the selection, an associated case specific scoring table 60 is utilized. In either case, the case specific scoring table 60 is built ahead of time, and then made available to the on-demand profiling system 10 to profile jurors during, e.g., a voire dire process.

Survey data 20 generally includes a robust set of survey records (e.g., 3,000+ records) that includes attributes, survey questions and responses of individuals who were surveyed and responded to relevant questions. Survey data 20 may be collected using standard survey techniques or via a web application. Questions provided may include not only responses to demographic and case specific fact patterns, but also, feelings towards crime and punishment, lawyers, lawsuits, corporations, the legal system, etc. The answer to each question may be a value, e.g., between 1-5, where 5 indicates a favorable response, and 1 indicates a negative response. Thus, each survey data record may look as follows:
Name=xxxxx; attributes={A1=a1 ;A2=a2;A3=a3 ;etc}; answers={Q1=1;Q2=3 ;Q3=2; etc}, where A1, A2, A3 are particular attribute categories (e.g., gender, age and income) and a1, a2 and a3 are attribute values (e.g., male, 35, $75,000) of the person being surveyed, and Q1, Q2, Q3 are questions asked in the survey that store answers to the particular questions.

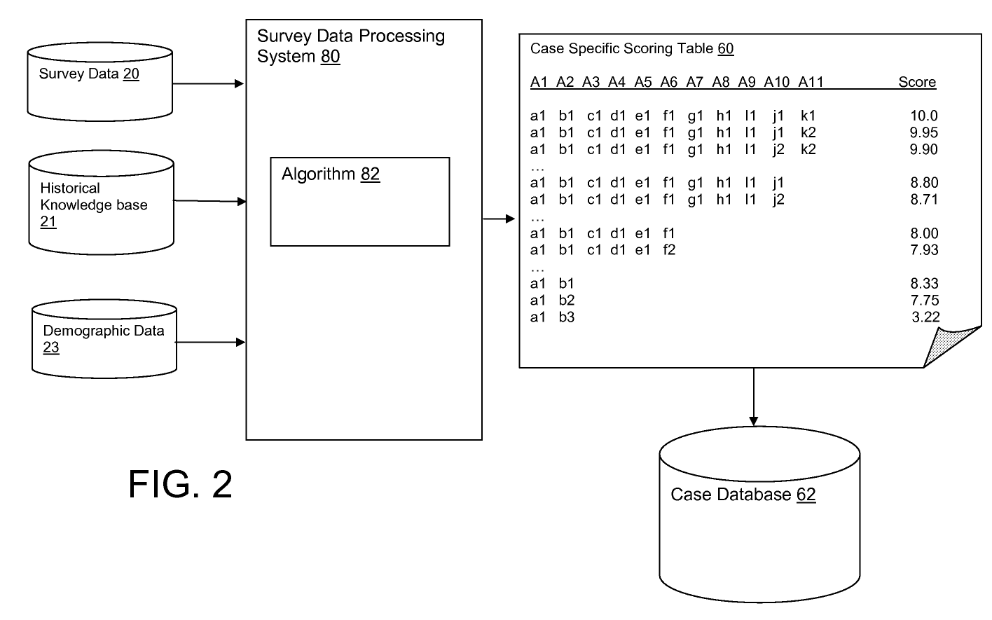

FIG. 2 depicts an illustrative embodiment for building a case specific scoring table 60 from a set of survey data 20. As noted above, each person being surveyed is asked to disclose a set of attributes about themselves, e.g., gender, age, race, income, etc., as well as a likelihood of liability for one or more fact patterns. Survey data processing system 80 includes an algorithm 82 for transforming the survey results into a scoring table 60. Any type of algorithm 82 may be utilized, including for example, a boosted classification and regression tree algorithm.

In an illustrative boosted classification and regression tree algorithm, the following demographic variables are used to predict a potential juror's response:
1: age in years
2: education level
3: political party
4: race
5: how urban it is where you live
6: religion
7: child living at home or not
8: marital status
9: own or rent home
10: income
11: gender

A set of hypothetical case survey questions/responses are then utilized to train the algorithm 82 to predict responses for a corresponding case. There are two principal kinds of outputs. One is a probability predicting how a potential juror matching a defined set of attributes will respond to a particular question about a particular case. Each hypothetical case will present the respondent with a fact pattern and a set of possible responses relating to liability. For example, the following responses or “liability findings” may be presented:
1. Not liable 2. Probably not liable 3. Neutral 4. Probably liable 5. Liable or
1. Not guilty 2. Probably not guilty 3. Neutral 4. Probably guilty 5. Guilty.

The illustrative algorithm 82 may be implemented as a simplified, binary version of the responses. That is, a response of 1, 2, or 3 is recoded as a response of “0”, while a response of 4 or 5 is recoded as a response of “1”. Consequently, responses may be classified as either “0”, corresponding to a neutral to not guilty or liable judgment, or “1”, corresponding to a probably liable or guilty to liable or guilty judgment. For a given question about a given case, the algorithm 82 yields a probability between 0 and 1 (i.e., a score). This is the probability that the potential juror will make a judgment of probably liable or guilty or liable or guilty.

Note that depending on which side an attorney user is on, either a response of 1, 2, or 3 or a response of 3, 4, or 5 corresponds to a juror who is neutral or disposed towards finding in the client's favor. The principle is to avoid potential jurors who are “worse than neutral” for the attorney's client.

The second output is a confidence interval for the classification accuracy of the predictions the algorithm 82 makes about a given question for a given case. The accuracy is the estimated fraction of potential jurors for which the algorithm makes a correct classification of 0 or 1. For this purpose, a probability or score greater than 0.5 is interpreted as a classification of 1, while a score of 0.5 or less is interpreted as a classification of 0.

The confidence interval is a range of accuracies with an associated confidence level or percentage. For example, the accuracy of the algorithm predictions for a selected question for a selected case may be computed to be from 0.64 to 0.65, with 66% confidence. This means there is a 66% chance that the actual accuracy of the algorithm 82 in this instance is between 0.64 and 0.65. In other words, between 64% and 65% of the classifications made by the algorithm 82 for the question will be correct, with 66% confidence. There is a 34% chance the classification accuracy is actually better (over 65%) or worse (under 64%). Another way to state this is that the odds the accuracy is between 64% and 65% are about 2 to 1.

The probabilities and accuracy are determined by a type of computer algorithm called boosted classification and regression trees, or boosted CART. A particular version of this, called “arc-fs” was implemented. See, Breiman, “Arcing Classifiers” in Annals of Statistics 26, 801-849, 1998, and Breiman, Friedman, Olshen, and Stone, “Classification and Regression Trees”, Chapman and Hall, New York, 1984. The algorithm 82 is run for one case-related question at a time. The survey response data are used to train the algorithm 82 to predict a potential juror's response based on the demographic variables.

For each case question, a fixed number, e.g., fifty, random samples of the responses to the question are taken to train one “boosted classification tree”. Each of these samples is a so-called “bootstrap” sample (see, Efron and Tibshirani, “An Introduction to the Bootstrap”, Chapman and Hall, New York, 1993.) which, on average, consists of about two-thirds of all different responses. (The particular two-thirds of the data changes each time a bootstrap sample is taken.) The entire bootstrap sample includes the same number of items as the total number of responses, but about one third of these are repetitions of other items in the sample.

Each bootstrap sample of the data is used to train the algorithm, a tree which classifies each juror as “0”, more likely to find not guilty, or “1”, more likely to find guilty. All of the data, including the remaining third, is checked to see how accurately it is classified after the most recent training of the algorithm. The accuracy with which each case is classified determines the way in which the next bootstrap sample is selected and how additional training with the sample modifies the algorithm. (See, Hastie, T., Tibshirani, R., and Friedman, J. “The Elements of Statistical Learning: Data Mining, Inference, and Prediction”, Springer, 2001, and Sobel, M., Swartz, K., and Fairley, W. “Boosting to Predict the Status of Un-identified Customer Payments to a Business.” Presented at ISBIS-2007, Azores, Portugal.) Each additional bootstrap sampling and training from the sample is said to boost the classification tree, and improves the accuracy. This boosting is repeated, e.g., fifty times, and results in one boosted tree.

Consequently, fifty boosted trees are created for a single case question. Each of the boosted trees produces a different score for each potential juror. Then the predictions for each potential juror are averaged over the fifty boosted trees. This gives the predicted probability that the potential juror will be classified as “1”, i.e., the predicted probability the individual will judge the defendant guilty or liable.

A very similar procedure is used to find a confidence interval for the algorithm's accuracy of classification for data not used to train or create the algorithm 82. The main modification is that for this purpose the data are randomly divided into two parts. One-half (the “training” set) is used to produce a boosted tree. The other half (the “test” set) is used to find the test classification accuracy of the boosted tree. This is repeated, e.g., fifty times, to produce fifty boosted trees with fifty associated test accuracies. The range of accuracies of the fifty trees for a single question are examined to get the confidence interval for the accuracy of the algorithm 82 in predicting individual judgments of prospective jurors.

More precisely, for a given confidence level, the accuracies are ordered, and a percentage, equal to the confidence level percentage, of all ordered accuracies is taken about the center of the ordered list. If, for example, there were 10 accuracies in an ordered list: (0.60, 0.61, 0.62, 0.63, 0.64, 0.65, 0.66, 0.67, 0.68, 0.69), the middle 8 numbers, from 0.61 to 0.68 would be taken to cover the 80% confidence interval, which would thus be the interval from 61% to 68% test accuracy.

The resulting case specific scoring table 60 includes entries that group attribute categories (e.g., A1, A2, A3) and attribute values (e.g., a1, b1, b2, etc.) from the survey data 20. Attribute categories include, e.g., gender, age, religion, political affiliations, etc., and associated values include, e.g., male or female; 21-30, 31-40 . . . ; Catholic, Jewish, Muslim, . . . ; Republican, Democrat . . . ; etc. In the illustrative embodiment shown here, there are 11 such attributes that are collected during the survey. However, it is understood that the number and type of attributes collected can vary. A score is calculated for to each such entry which reflects a likelihood that an individual matching a set of attribute combinations would find for the plaintiff. For instance, based on the survey data 20, it may be determined that given the fact pattern of the case, females with an age between 31 and 40, having an income between $50-100 k, who are registered democratic, own their own home, are married with children, white, Catholic, and have attended college, would have a high likelihood of finding for the plaintiff and be given a score of 9.90.

Algorithm 82 also calculates scores for subsets of the attribute categories. For instance, there may be instances where only the gender and age of a potential juror is known. Thus, as shown in FIG. 2, scoring table 60 determines a score of 8.33 if the only known attribute for values were a1 and b1 for categories A1 and A2. Any number of different attribute combinations may be calculated.

Once the attributed juror records 46 for a set of jurors is identified from the attributed juror pool database 28, the attributed juror records 46 are submitted to scoring system 24, which may score and rank selected jurors in an on demand dynamic fashion. Scoring system 24 includes a matching system 50 for comparing an attributed juror record 44 with the case specific scoring table 60 to generate a score for the juror. In particular, matching system will examine the attributes in a juror record (e.g., female, age 30, registered democrat, home owner, income of $80,000, etc.) and attempt to match the attributes with one of the attribute combinations (i.e., entries) in the case specific scoring table 60. If the juror matches all of the attributes of one of the entries in the scoring table, then a score is assigned to that juror based on the value associated with the entry.

In the case where only some of the attributes are known about a juror (e.g., male, age 45, registered republican), a score will be calculated from the answers of survey respondents with the same attributes.

In the case where the attributes of the juror does not exactly match any of the entries in the scoring table, matching system 50 can iteratively remove attributes from the juror until a match is achieved. For instance, the juror may be a female, age 68, religion Hindu, income $250,000, registered independent, with a PhD. It may be the case that the survey used to build the scoring table 60 did not survey any person with those attributes. Accordingly, matching system 50 may eliminate one of the attributes, e.g., religion, and attempt to match the remaining attributes with entries in the scoring table 60. This would iteratively occur until a match was identified.

In addition to survey data 20, survey data processing system 80 may also utilize historical knowledge base 21 and demographic data 23 to further refine the scores in the scoring table 60. For instance historical knowledge base 21 may include results from past cases regarding how jurors with certain attributes voted. Demographic data 23 may be used to augment the survey data 20, e.g., average home values by zip code could be determined and added as another attribute.

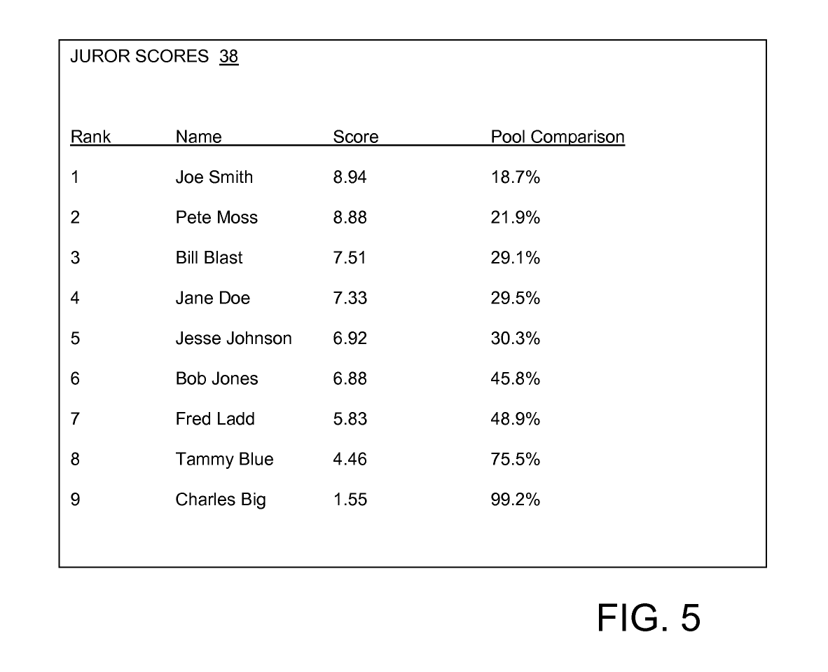

Ranking system 52 ranks a set of selected jurors, e.g., from most likely to find in favor of the plaintiff to least likely. FIG. 5 depicts a set of juror scores 38 ranked in this manner. In this example, nine jurors are shown with their respective scores that range from 0-10, with 10 being most likely to find for the plaintiff. Given this data, the user 12, i.e., trial attorney, can easily identify jurors that should ideally be kept and removed from the jury during voire dire.

Also included in scoring system 24 is pool analysis system 54 (FIG. 1) that compares each juror to the rest of the pool (e.g., the county jury pool). This procedure will typically be done by determining a score for each individual in the database 38 ahead of time. As juror scores are returned from the scoring system 24 they will be compared to all the remaining scores of individuals left in the potential jury pool. Accordingly, to implement pool analysis system, each individual (or at least some meaningful sample of individuals) in the jurisdiction will be pre-scored. A score may be updated using the user revision system 56 (described below) by the user 12 changing the scoring attributes based on observed or reported data, but the pre-scoring can be done in a batch manner prior to look up. Each name in the pool, e.g., 100,000 individuals, is thus assigned a score based on the demographics stored in the attributed jury pool database 28. This “pre-scoring” would typically only be done in custom applications, in which additional time and costs are acceptable to score the entire database.

In an alternative embodiment, in order to save computation time, a subset or sample of the attributed jury pool database 28 (as opposed to the entire database) could be scored for use by pool analysis system 54. Scoring of the sample could thus be done on the fly to eliminate the need to pre-score the entire database 28.

Pool analysis system 54 allows the user 12 to get a sense of the likelihood that a challenge to a juror would result in a better candidate. For instance, as shown in FIG. 5, each juror has a “pool comparison” percentage that indicate how many people in the pool have a higher score. As an example, Fred Ladd has a score of 5.83, which is relatively low. However, only 48.9% of the people in the pool have a higher score. Thus, the user 12 may not want to challenge/replace Fred Ladd because the odds are 51.1% that the replacement will have a lower score. Additional pool data may also be provided, e.g., a histogram of different score ranges based on the number of persons in each range, etc.

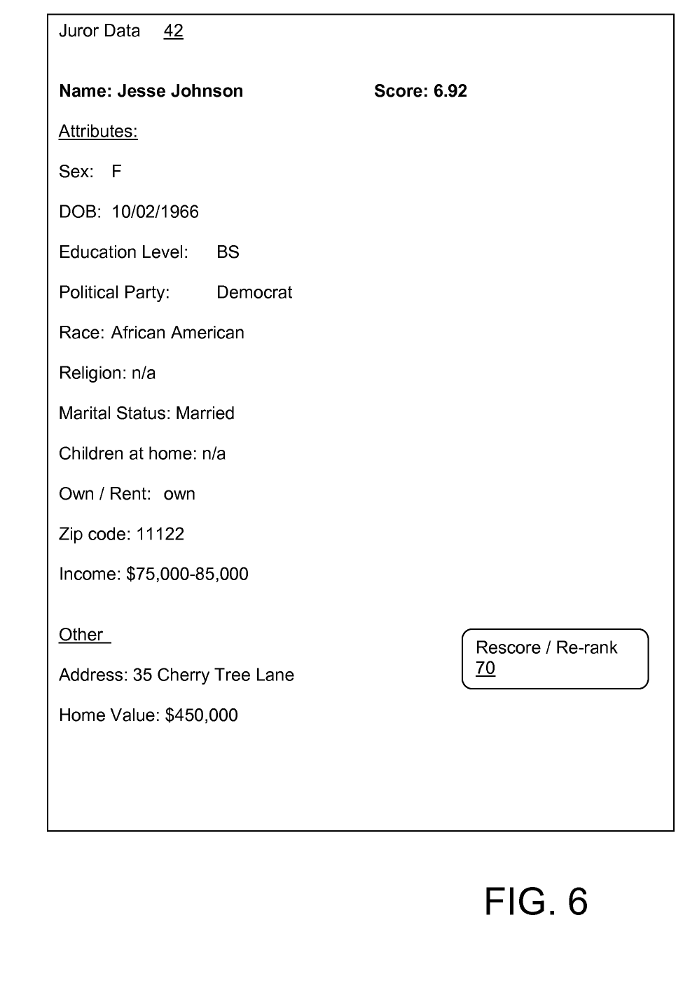

From the results shown in FIG. 5, the user 12 can select one of the jurors to review the juror's data 42. A resulting example is shown in FIG. 6, which shows the various attributes categories and values used in the scoring process, as well as “Other” data that is known about the juror. In some cases, the attorney, during voire dire, may be able to discern unknown or incorrect attribute values listed for the juror. Scoring system 24 includes a user revision system 56 that allows the user 12 to revise information in the juror data 42. For instance, the user 12 may notice that Jesse Johnson, although listed as female is actually a male, or may notice that Jesse is wearing a cross on a necklace indicating that Jesse's religion is likely Christian. User 12 can make these changes directly into the interface shown in FIG. 6, e.g., using the mouse pointer to activate a drop down box or the like. Once entered, user 12 can select the rescore/re-rank button 70 to dynamically rescore and re-rank the juror with the updated information. The ability to change attribute values in this manner can be significant given the fact that public and private databases often contain incorrect or old information.

As shown in FIG. 3, attributed jury pool database 28 is built from a jury pool database 32 that is augmented by an attribute system 30. Jury pool database 32, which comprises a list of all of the available jurors for the particular jurisdiction, is regularly updated with juror records 36 obtained from publicly available voter files, property records, etc. Thus, jury pool database 32 essentially mirrors the same records used by a court to select jurors.

Attribute system 30 appends attribute data 34 to each juror record 36 in the jury pool database 32. The attribute data 34 may include any data that describes a juror (e.g., age, political affiliations, gender, address, income, property ownership, voting record, consumer data, etc.). Attribute data 34 may be obtained from any private or publicly available source including census data, consumer data, crime data, survey data, etc. A merge system 31 may be utilized to merge data from different databases to provide a clean set of data. Accordingly, the resulting attributed jury pool database 28 comprises a robust set of information for each available juror in a given jurisdiction.

FIG. 4 depicts a simple example of a few attributed juror records that could appear in the attributed jury pool database 28. As can be seen, for each name, various attribute data 34 is also provided. Obviously, the type and amount of attribute data 34 collected can vary depending on the particular circumstances, e.g., availability, importance, etc. Moreover, it should be understood that any technique or methodology may be employed for building the attributed jury pool database 28.

In addition to the real-time profiling described above, once identified, user 12 can forward the prospective juror's name to a background checking system 22 (FIG. 1), which can perform, e.g., a criminal background check on the prospective juror. Once obtained, the background data can be forwarded back to the user 12 via GUI 16.

In general, on demand profiling system 10 may be implemented on any type of computer system including as part of a client and/or a server. Such a computer system may generally include a processor, input/output (I/O), memory, and bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Additional components, such as cache memory, communication systems, system software, etc., may be incorporated into the computer system.

Access to the computer system may be provided over a network 14 such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system comprising a real-time profiling system could be created, maintained and/or deployed by a service provider that offers the functions described herein for customers. That is, a service provider could offer to provide real-time profiling as described above. Such as service could include multi-tiered pricing based on a monthly subscription and per name look up fees.

It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A profiling system for profiling prospective jurors, comprising:
at least one computing device including:
a system for generating a case specific scoring table based on a set of survey data, wherein the survey data includes attribute data for a set of respondents and liability findings from the set of respondents for at least one hypothetical case, wherein the case specific scoring table provides a score for each of a plurality of attribute combinations, wherein the system for generating the case specific scoring table further generates a confidence interval indicating an accuracy of each of the plurality of attribute combinations;
an attributed jury pool database for storing a set of attributed juror records;
an interface for selecting a potential juror from the attributed jury pool database; and
a system for scoring the potential juror by comparing attributes of the potential juror with the attribute combinations in the case specific scoring table, wherein the system for scoring further includes:
a pool analysis system for comparing each selected potential juror in a set of selected potential jurors to a group of unselected potential jurors in a potential jury pool, the pool analysis system generating a pool comparison percentage assigned to each selected potential juror indicating a likelihood that each selected potential juror will have a higher score than a juror in the group of unselected potential jurors.

2. (canceled)

3. The profiling system of claim 1, wherein the attribute data is selected from the group consisting of: age in years, education level, political party, race, how urban it is where the respondent lives, religion, child living at home or not, marital status, own or rent home, income and gender.

4. The profiling system of claim 1, further comprising:
a system for interactively revising attribute data for the potential juror based upon an entry by a user indicating a human observation of the potential juror; and
re-scoring the potential juror based on the revision to the attribute data of the potential juror.

5. (canceled)

6. The profiling system of claim 1, further comprising a system for outputting a ranked set of juror scores.

7. The profiling system of claim 1, further comprising a case management system for selecting a case from a set of cases, wherein each case includes an associated case specific scoring table.

8. A computer readable storage medium having a computer program product stored thereon for profiling prospective jurors, comprising:
program code for generating a case specific scoring table based on a set of survey data, wherein the survey data includes attribute data for a set of respondents and liability findings from the set of respondents for at least one hypothetical case, wherein the case specific scoring table provides a score for each of a plurality of attribute combinations, wherein the program code for generating the case specific scoring table further generates a confidence interval indicating an accuracy of each of the plurality of attribute combinations;
program code for selecting a potential juror from an attributed jury pool database; and
program code for scoring the potential juror by comparing attributes of the potential juror with the attribute combinations in the case specific scoring table, wherein the program code for scoring further includes:
program code for comparing each selected potential juror in a set of selected potential jurors to a group of unselected potential jurors in a potential jury pool by generating a pool comparison percentage assigned to each selected potential juror indicating a likelihood that each selected potential juror will have a higher score than a juror in the group of unselected potential jurors.

9. (canceled)

10. The computer readable medium of claim 8, wherein the attribute data is selected from the group consisting of: age in years, education level, political party, race, how urban it is where the respondent lives, religion, child living at home or not, marital status, own or rent home, income and gender.

11. The computer readable medium of claim 8, further comprising:
program code for interactively revising attribute data for the potential juror based upon an entry by a user indicating a human observation of the potential juror; and
program code for re-scoring the potential juror based on the revision to the attribute data of the potential juror.

12. (canceled)

13. The computer readable medium of claim 8, further comprising program code for outputting a ranked set of juror scores.

14. The computer readable medium of claim 8, further comprising program code for selecting a case from a set of cases, wherein each case includes an associated case specific scoring table.

15. A method for profiling prospective jurors performed using at least one computing device, comprising:
generating a case specific scoring table based on survey data using the at least one computing device, wherein the survey data includes attribute data for a set of respondents and liability findings from the set of respondents for at least one hypothetical case, wherein the case specific scoring table provides a score for each of a plurality of attribute combinations, wherein the generating of the case specific scoring table further includes generating a confidence interval indicating an accuracy of each of the plurality of attribute combinations;
selecting a potential juror from an attributed jury pool database;
scoring the potential juror by comparing attributes of the potential juror with the attribute combinations in the case specific scoring table using the at least one computing device; and
comparing each selected potential juror in a set of selected potential jurors to a group of unselected potential jurors in a potential jury pool by generating a pool comparison percentage assigned to each selected potential juror indicating a likelihood that each selected potential juror will have a higher score than a juror in the group of unselected potential jurors.

16. (canceled)

17. The method of claim 15, wherein the attribute data is selected from the group consisting of: age in years, education level, political party, race, how urban it is where the respondent lives, religion, child living at home or not, marital status, own or rent home, income and gender.

18. The method of claim 15, further comprising:
interactively revising attribute data for the potential juror based upon an entry by a user indicating a human observation of the potential juror; and
re-scoring the potential juror based on the revision to the attribute data of the potential juror.

19. (canceled)

20. The method of claim 15, further comprising outputting a ranked set of juror scores.

21. The method of claim 15, further comprising selecting a case from a set of cases, wherein each case includes an associated case specific scoring table.

22. A profiling system for profiling prospective jurors, comprising:
at least one computing device including:
a case management system for selecting a case from a set of cases, wherein each of the set of cases includes a case specific scoring table based on a set of survey data, wherein the survey data includes attribute data for a set of respondents and liability findings from the set of respondents for at least one hypothetical case, wherein each case specific scoring table provides a set of scores for each of a plurality of attribute combinations, wherein the case management system further generates a confidence interval indicating an accuracy of each of the plurality of attribute combinations;
an attributed jury pool database for storing a set of attributed juror records;
an interface for selecting a potential juror from the attributed jury pool database; and
a system for scoring the potential juror by comparing attributes of the potential juror with the attribute combinations in a case specific scoring table associated with a selected case, wherein the system for scoring further includes:
a pool analysis system for comparing each selected potential juror in a set of selected potential jurors to a group of unselected potential jurors in a potential jury pool, the pool analysis system generating a pool comparison percentage assigned to each selected potential juror indicating a likelihood that each selected potential juror will have a higher score than a juror in the group of unselected potential jurors.

23. The system of claim 1, wherein the system for scoring the potential juror further compares a subset of the attributes of the potential juror with a subset of the attribute combinations in the case specific scoring table in the case that attributes of the potential juror do not match attributes combinations in the case specific scoring table.

24. The system of claim 23, wherein the system for scoring the potential juror iteratively removes an attribute from the attributes of the potential juror until the subset of attributes of the potential juror match the subset of the attribute combinations in the case specific scoring table.

25. The computer readable storage medium of claim 8, wherein the program code for scoring the potential juror further compares a subset of the attributes of the potential juror with a subset of the attribute combinations in the case specific scoring table in the case that attributes of the potential juror do not match attributes combinations in the case specific scoring table.

26. The computer readable storage medium of claim 25, wherein the program code for scoring the potential juror iteratively removes an attribute from the attributes of the potential juror until the subset of attributes of the potential juror match the subset of the attribute combinations in the case specific scoring table.

27. The method of claim 15, further comprising comparing a subset of the attributes of the potential juror with a subset of the attribute combinations in the case specific scoring table in the case that attributes of the potential juror do not match attributes combinations in the case specific scoring table.

28. The method of claim 27, further comprising iteratively removing an attribute from the attributes of the potential juror until the subset of attributes of the potential juror match the subset of the attribute combinations in the case specific scoring table.
